(19) United States
(12) Patent Application Publication
(10) Pub. No.: US 2025/0384493 A1
(43) Pub. Date: Dec. 18, 2025

(54) Systems and Methods for Optimally Matching Users of A Media Platform

(71) Applicant: Vbrato, LLC, Dothan, AL (US)

(72) Inventors: Joseph Harrison Sikora, Brookhaven, GA (US); William Frank McCann, Matawan, NJ (US)

(21) Appl. No.: 18/744,295

(22) Filed: Jun. 14, 2024

(51) Int. Cl. G06Q 50/00; G06Q 10/10

(52) U.S. Cl. CPC G06Q 50/01; G06Q 10/103

(57) ABSTRACT

An artist collaboration platform determines an artist vector for a plurality of artists using the artist collaboration platform. The artist collaboration platform determines a vector distance between each artist of the artist collaboration platform and optimally matches a first artist with a complementary artist based on minimizing a vector distance between the first artist and the complementary artist. The artist collaboration platform enables an artist to set collaboration requirements, set ownership and payment terms for a given collaboration, review collaboration submissions, and accept a desired collaboration submission. Upon acceptance of a collaboration, the artist collaboration platform accepts payments which are held in escrow until the collaboration are completed. The artist collaboration platform can automatically generate a legal document summarizing the ownership and payment terms surrounding an accepted collaboration submission using document generation logic.

### FIELD

Embodiments of the invention are generally related to a media platform for matching users for collaboration based on user similarity, including determining minimal distances between artist profiles.

### BACKGROUND

Currently, musicians and other creatives face significant difficulty in finding others to collaborate with in order to mutually enhance their professional profiles. Most creatives seek services of talent management companies which provide opportunities to enhance creative professional profiles in exchange for ownership over the creative output of the creative. Those creatives that want to avoid giving up ownership rights over their creative output face difficulty in identifying other creatives to collaborate with. Even when a creative can find a collaborator, the creative still faces difficulty in negotiating the terms of the collaboration, safely exchanging payment for the collaboration, and negotiating the terms of ownership of any collaborative work.

Embodiments of the present disclosure address these and other issues.

### BRIEF DESCRIPTION OF THE DRAWINGS

The above and other features of the present disclosure, its nature and various advantages will be more apparent upon consideration of the following detailed description, taken in conjunction with the accompanying drawings in which:

FIG. 1 is a diagram of an artist collaboration system including an artist collaboration platform in accordance with some embodiments of the present disclosure.

FIG. 2 is a block diagram of select component parts of an artist collaboration platform in accordance with some embodiments of the present disclosure.

FIG. 3 is an exemplary flowchart representing various functionalities of the artist collaboration platform in accordance with some embodiments of the present disclosure.

FIG. 4 is an exemplary flowchart of a process of computing an artist matrix in accordance with some embodiments of the present disclosure.

FIG. 5 is an exemplary flowchart of a process of identifying a collaboration match in accordance with some embodiments of the present disclosure.

FIG. 6A is an exemplary graphical user interface in accordance with some embodiments of the present disclosure.

FIG. 6B is an exemplary graphical user interface in accordance with some embodiments of the present disclosure.

FIG. 7 is an exemplary graphical user interface in accordance with some embodiments of the present disclosure.

FIG. 8A is an exemplary graphical user interface in accordance with some embodiments of the present disclosure.

FIG. 8B is an exemplary graphical user interface in accordance with some embodiments of the present disclosure.

FIG. 9A is an exemplary graphical user interface in accordance with some embodiments of the present disclosure.

FIG. 9B is an exemplary graphical user interface in accordance with some embodiments of the present disclosure.

FIG. 10A is an exemplary graphical user interface in accordance with some embodiments of the present disclosure.

FIG. 10B is an exemplary graphical user interface in accordance with some embodiments of the present disclosure.

FIG. 11A is an exemplary graphical user interface in accordance with some embodiments of the present disclosure.

FIG. 11B is an exemplary graphical user interface in accordance with some embodiments of the present disclosure.

FIG. 12A is an exemplary graphical user interface in accordance with some embodiments of the present disclosure.

FIG. 12B is an exemplary graphical user interface in accordance with some embodiments of the present disclosure.

FIG. 12C is an exemplary graphical user interface in accordance with some embodiments of the present disclosure.

FIG. 12D is an exemplary graphical user interface in accordance with some embodiments of the present disclosure.

FIG. 13A is an exemplary graphical user interface in accordance with some embodiments of the present disclosure.

FIG. 13B is an exemplary graphical user interface in accordance with some embodiments of the present disclosure.

FIG. 13C is an exemplary graphical user interface in accordance with some embodiments of the present disclosure.

FIG. 13D is an exemplary graphical user interface in accordance with some embodiments of the present disclosure.

FIG. 14A is an exemplary graphical user interface in accordance with some embodiments of the present disclosure.

FIG. 14B is an exemplary graphical user interface in accordance with some embodiments of the present disclosure.

FIG. 14C is an exemplary graphical user interface in accordance with some embodiments of the present disclosure.

FIG. 15A is an exemplary graphical user interface in accordance with some embodiments of the present disclosure.

FIG. 15B is an exemplary graphical user interface in accordance with some embodiments of the present disclosure.

FIG. 15C is an exemplary graphical user interface in accordance with some embodiments of the present disclosure.

FIG. 16A is an exemplary graphical user interface in accordance with some embodiments of the present disclosure.

FIG. 16B is an exemplary graphical user interface in accordance with some embodiments of the present disclosure.

In the figures, the left-most digit(s) of a reference number identifies the figure in which the reference number first appears. The use of the same reference numbers in different figures indicates similar or identical items or features. Moreover, multiple instances of the same part are designated by a common prefix separated from the instance number by a dash. The drawings are not to scale.

### DETAILED DESCRIPTION

The systems and methods described herein may be used to provide creatives (e.g., artists, musicians, etc.) with a platform that enhances their ability to effectively collaborate to generate new creative works, enhance their professional profiles, negotiate common ownership rights, and safely exchange payment for collaborative work without relying on external agencies, such as talent management agencies. An exemplary system may retrieve profile data from a variety of common platforms (e.g., Spotify, YouTube, etc.), either directly from each platform or through a data aggregator that extracts and stores creative profile data for each user (also referred to herein as “entity”) using the respective platform. The exemplary system may normalize the retrieved profile data and use the profile data to generate profile vectors for each user corresponding to the retrieved profile data. The system may use the profile vectors to determine vector distances between each profile vector corresponding to a user profile vectors corresponding to complementary users for which profile vectors have been generated. The exemplary system may take in input from a user (entity) regarding a type of collaboration that the user desires. The system may use the determined vector distances to match the user with one or more second users based on the input from the user and the vector distances determined by the exemplary system.

In some embodiments, the one or more second users may be provided to the first user in response to the input, and the first user can select one of the one or more second users to initiate a collaboration. The input can include requirements for the collaboration, and can the selected second user can prepare a sample according to the requirements. In some embodiments, the first user and the selected second user can use the system to negotiate requirements included in the input.

In some embodiments, the system can allow users to fund accounts that are controlled by the system. Once a collaboration between a first user and a second user is accepted, the second user may receive a portion of the negotiated payment from the fund account of the first user. The remaining portion of the negotiated payment may be provided from the fund account of the first user to the fund account of the second user in response to the second user submitting a finalized collaboration file to the first user through the system and the finalized collaboration file being accepted by the first user.

In some embodiments, the system can include document generation logic that can receive the collaboration terms between users, and once the collaboration is finalized, automatically generate a legal document that states the terms of the collaboration. In some embodiments, the generated legal document can include terms specifying the percentage ownership of the copyright over the resulting work, the percentage ownership over the master recording, the percentage ownership over the publishing rights, etc.

In some embodiments, the system allows users to create and post “collaboration requests” to the system. The collaboration requests include user specified parameters associated with the desired collaboration (e.g., backing vocals to a rock track), payment terms, ownership terms, required marketing terms (e.g., a minimum of two posts to Instagram advertising the collaboration), etc. The system can then display open collaboration requests to users depending on the vector distance between the requesting user and the user searching for a user to collaborate with.

In some embodiments, the system can provide recommended collaborations to a first user that may be based in part on search criteria of a second user. In other words, the system can recommend to a first user to respond to a collaboration request (e.g., by populating a feed of the first user) based on the first user matching the user specified parameters that a second user inputs to the system without the second user being notified that the first user has been recommended to respond to the collaboration request.

Conventional solutions may use methods such as content based filtering and collaborative filtering in order to match users. These conventional techniques can involve using metadata associated with a user to recommend collaborations based on previously accepted collaborations (content based filtering) and/or making predictions based on collecting information from many users, grouping users into groups, and making high level predictions for group members (collaborative filtering).

In contrast, the systems and methods described herein uses a model that builds a user profile for each user utilizing the platform (e.g., by generating artist profile vectors), and determines similarity among all users of the platform (e.g., by calculating vector distances between the artist profile vectors). The disclosed systems and methods also allow a user to select which aspect of the user profile the user wishes to maximize, and the disclosed systems and methods can dynamically adjust weights of parameters within user profile to maximize different aspects of the user profile. Further still, unlike conventional solutions, the solutions described herein automatically record and generate a document summarizing the terms of a collaboration once accepted, and provide for a secure platform that funds the collaborating user after the collaboration has been successfully completed.

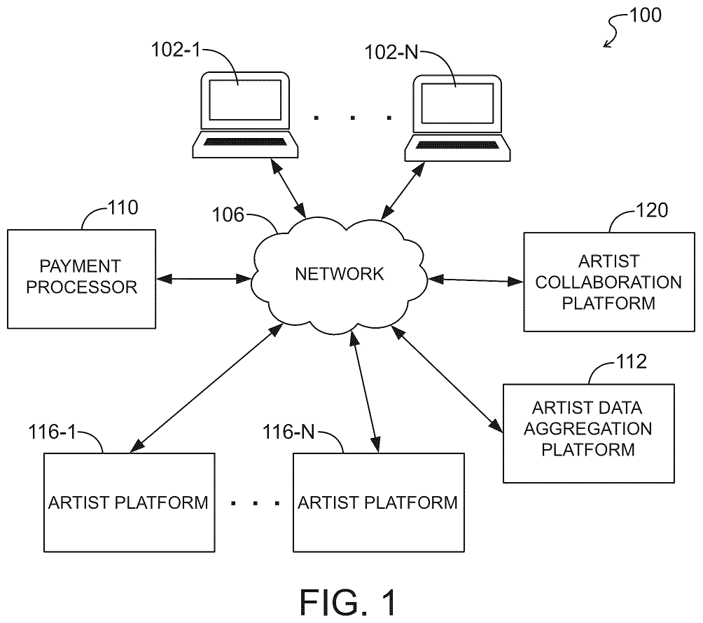

FIG. 1 is a block diagram of an example system 100 in which artist collaboration platform 120 may operate, according to an example implementation of the disclosed technology. The components and arrangements shown in FIG. 1 are not intended to limit the disclosed embodiments as the components used to implement the disclosed processes and features may vary. As shown, artist collaboration platform 120 may interact with a user device 102 via a network 106. In certain example implementations, the system 100 can include one or more user devices 102-1, 102-2, . . . , 102-N, a payment processor 110, an artist data aggregation platform 112, one or more artist platforms 116-1, 116-2, . . . , 116-N, and the artist collaboration platform 120.

In some embodiments, a user may operate the user device 102. The user device 102 can include one or more of a mobile device, smart phone, general purpose computer, tablet computer, laptop computer, smart wearable device, voice command device, other mobile computing device, or any other device capable of communicating with the network 106 and ultimately communicating with one or more components of the system 100.

Users may include individuals such as, for example, subscribers, clients, prospective clients, or customers of artist collaboration platform 120. According to some embodiments, the user device 102 may include an environmental sensor for obtaining audio or visual data, such as a microphone and/or digital camera, a geographic location sensor for determining the location of the device, an input/output device such as a transceiver for sending and receiving data, a display for displaying digital images, one or more processors, and a memory in communication with the one or more processors. The network 106 may be of any suitable type, including individual connections via the internet such as cellular or WiFi networks. In some embodiments, the network 106 may connect terminals, services, and mobile devices using direct connections such as radio-frequency identification (RFID), near-field communication (NFC), Bluetooth™, low-energy Bluetooth™ (BLE), WiFi™, ZigBee™, ambient backscatter communications (ABC) protocols, USB, WAN, or LAN. Because the information transmitted may be personal or confidential, security concerns may dictate one or more of these types of connections be encrypted or otherwise secured. In some embodiments, however, the information being transmitted may be less personal, and therefore the network connections may be selected for convenience over security.

The network 106 may include any type of computer networking arrangement used to exchange data. For example, the network 106 may be the Internet, a private data network, virtual private network (VPN) using a public network, and/or other suitable connection(s) that enable(s) components in the system 100 environment to send and receive information between the components of the system 100. The network 106 may also include a PSTN and/or a wireless network.

Payment processor 110 may include a computer system configured to provide one payment processing services to users of artist collaboration platform 120, as well as any individuals involved with user devices 102. Payment processor 110 may include a computer system configured to receive communications from artist collaboration system 110 and or user devices 102 to provide payment processing services. Payment processor 110 may have one or more processors and one or more databases, which may be any suitable repository of financial account data of user associated with user devices 102. Information stored by payment processor 110 may be accessed by one or more devices or systems of system 100. According to some embodiments, payment processor 110 may include software tools that may allow payment processor 110 to obtain network identification data from user devices 102 and transfer account funds between users of artist collaboration platform 120. The payment processor 110 may also be hosted by an online provider of website hosting, networking, cloud, or backup services, such as Microsoft Azure™ or Amazon Web Services™. It should be understood that although payment processor 110 is shown as a single service, in some embodiments, there may be any number of artist payment processors 110 (e.g., payment processor 110-1, payment processor 110-2, . . . , payment processor 110-N) that can be utilized by users of user devices 102 to transfer account funds between users of artist collaboration platform 120.

Artist platforms 116 (e.g., artist platform 116-1, 116-2, . . . , 116-N) are platforms which artists use for various purposes, such as hosting music, communicating via social media, etc., and which store artist data associated with each participating artist. Artist platforms 116 can include services such as X™ (formerly Twitter™), Facebook™, Deezer™, Spotify™, Instagram™, Tik Tok™, YouTube™, etc. Each Artist platform 116 can store data associated with an artist (e.g., user or entity). For example, YouTube™ can store artist data such as subscribers, views, likes, comments, and engagement rate associated with an artist profile. Spotify™ can store artist data such as monthly listeners, playlist reach, fan conversion rate, popularity, and followers associated with an artist profile. According to some embodiments, monthly listeners on Spotify can be expressed as an integer (e.g., between 0 and 100,000,000) in a skewed distribution. Playlist reach on Spotify can be expressed as an integer in a skewed distribution. Fan conversion on Spotify can be expressed as a percentage in a normal distribution. Popularity on Spotify can be expressed as an integer score in a uniform distribution. Tik Tok can store artist data such as followers, views, likes comments, and engagement rates. According to some embodiments, followers on Tik Tok can be expressed as an integer in a skewed distribution. Views on Tik Tok can be expressed as an integer in a skewed distribution. Likes on Tik Tok can be expressed as an integer in a skewed distribution. Comments on Tik Tok can be expressed as an integer in a skewed distribution. The engagement rate on Tik Tok can be expressed as a percentage in a normal distribution. Instagram can store artist data such as followers, likes, comments, and engagement rate. According to some embodiments, followers on Instagram can be expressed as an integer in a skewed distribution. Likes on Instagram can be expressed as an integer in a skewed distribution. Comments on Instagram can be expressed as an integer in a skewed distribution. The engagement rate on Instagram can be expressed as a percentage in a normal distribution. X (Twitter) can store artist data such as followers. According to some embodiments, followers on X (Twitter) can be expressed as an integer in a skewed distribution. Deezer can store artist data such as fans. Fans on Deezer can be expressed as an integer in a skewed distribution. Facebook can store artist data such as fans, which can be expressed as an integer in a skewed distribution. It should be noted that additional artist data can be stored by each Artist platform 116, and that there may be more or fewer artist platforms 116 operating within system 100. It should also be understood that different artist platforms 116 can be configured to store other types of artist data that can be utilized by artist collaboration platform 120.

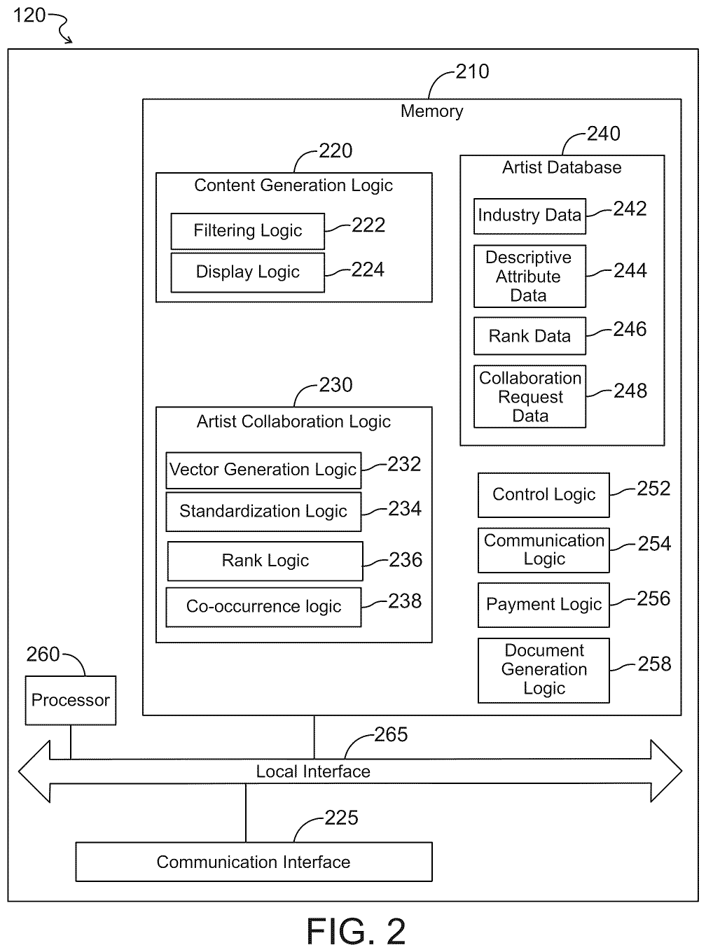

Artist data aggregation platform 112 may be a computer system which can aggregate artist (e.g., user/entity) data directly from respective artist platforms 116. For example, artist data aggregation platform 112 can include one or more processors and a memory that stores instructions to execute one or more application programming interfaces (APIs) that are configured to interact with artist platforms 116 to retrieve and store artist data associated with each artist that has an account on a respective artist data aggregation platform 112. In one example, artist data aggregation platform 112 can comprise Soundcharts™. It should be understood that although aggregation platform 112 is shown as a single service, in some embodiments, there may be any number of artist data aggregation platforms 112 (e.g., artist data aggregation platform 112-1, artist data aggregation platform 112-2, . . . , artist data aggregation platform 112-N) that each provide some to all of artist (e.g., user/entity) data to artist collaboration platform 120. Artist collaboration platform 120 is configured to receive and process artist data for artists utilizing artist collaboration platform 120. In certain disclosed embodiments, artist collaboration platform can determine optimal matches between artists utilizing artist collaboration platform 120. In certain disclosed embodiments, the artist collaboration platform can standardize data collected from artist platforms 116 in the process of determining of determining an optimal match between a first artist and a second artist. Artist collaboration platform 120 is described in more detail with respect to FIG. 2.

Although the preceding description describes various functions of payment processor 110, artist platform 116, artist data aggregation platform 112, user devices 102, and artist collaboration platform 120, in some embodiments, some or all of these functions may be carried out by a single computing device.

FIG. 2 depicts an example schematic diagram of certain components of artist collaboration platform 120 in accordance with some embodiments of the present disclosure. The artist collaboration platform 120 may include a memory 210. As used herein, the artist collaboration platform 120 may include a memory 210. As used herein, memory 210 may refer to any suitable storage medium, either volatile and non-volatile (e.g., RAM, ROM, EPROM, EEPROM, SRAM, flash memory, disks or optical storage, magnetic storage, or any other tangible or non-transitory medium) that stores information that is accessible by a processor. Memory 210 may store instructions used in the systems and methods described herein. While FIG. 2 illustrates a single discrete memory 210, it will be understood that the embodiments described herein are not limited to any particular arrangement and that other embodiments may store information in one combined memory, in one or more memories, some local to the other components illustrated in FIG. 2 and/or some shared with, or geographically located near, other remote computing systems.

The illustrated embodiment depicts a number of modules stored in memory 210, specifically content generation logic 220 (including filtering logic 222 and display logic 224), artist collaboration logic 230 (including vector generation logic 232, standardization logic 234, rank logic 236, and co-occurrence logic 238), control logic 252, communication logic 254, payment logic 256, and document generation logic 258. Memory 210 can also include data stores such as artist database 240 (including industry data 242, descriptive attribute data 244, rank data 246, and collaboration request data 248). These depicted modules may variously represent one or more algorithms, computational models, decision making rules or instructions, or the like implemented as software code or computer-executable instructions (i.e., routines, programs, objects, components, data structures, etc.) that, when executed by one or more processors 260, program the processor(s) to perform the particular functions of their respective logic. These modules are depicted in FIG. 2 as several discrete components, each labelled as an individual “logic”, however, in various embodiments, the functions of each respective logic may be executable on their own or as part of one or more other modules; that is, any configuration of the depicted logical components may be used, whether implemented by hardware, software, firmware, or any combination thereof. The capabilities of these various logics are described in greater detail below.

The artist collaboration platform 120 may include control logic 252, including one or more algorithms or models for generally controlling the operation of the artist collaboration platform 120. The memory 210 may also, in one embodiment, include communication logic 254, including one or more algorithms or models for obtaining information from or communicating information via network 106 (FIG. 1). The artist collaboration platform 120 may, via communication interface 225, operate to exchange data with various components and/or devices on the network 106 or any other network. For instance, communication interface 225 and communication logic 254 may be used (by, e.g., standard content generation logic 220 and/or artist collaboration logic 230 in the manner(s) described in greater detail below), to access data from one or more of artist platforms 116 and artist data aggregation platform 112. In some embodiments, communication logic 254 may use APIs provided by one or more of artist platforms 116 and artist data aggregation platform 112 to obtain stored data, however, other methods of data collection may alternatively be used such as one or more software development kits, which may include, e.g., one or more application programming interfaces (APIs), web APIs, tools to communicate with embedded systems, or any other appropriate implementation.

While communication logic 254 is illustrated as being a separate logical component, in an alternative embodiment, the artist collaboration platform 120 may include communication logic 254 as part of content generation logic 220, artist collaboration logic, or control logic 252. In another alternative embodiment, the communication logic 254 may communicate with the control logic 252 to read or write data to memory 210 or to another data repository (not shown) within the artist collaboration system 120.

In some embodiments, artist collaboration platform 120 may be implemented in whole or in part as a machine learning system (e.g., neural network software) for achieving the functionalities described herein. In one embodiment, one or more of filtering logic 222 and display logic 224, vector generation logic 232, standardization logic 234, rank logic 236, co-occurrence logic 238, and document generation logic 258 (or any subset of any of those logics) may be implemented at least in part as one or more machine learning algorithms. According to some embodiments, artist collaboration platform 120 may adjust various weights used to calculate vector distances between respective entities (e.g., users/artists, etc.) based on how users interact then artist collaboration platform 120. For example, artist collaboration platform 120 may monitor artist profiles a first artist interacts with, collaborates with, etc., and based on these various interactions address the weights of respective dimensions of artist vectors when calculating vector distances using vector generation logic 232. Similarly, when a second artist interacts with the first artist that is seeking a collaborator, artist collaboration platform 120 may alter weights used for calculating vector distances using vector generation logic 232.

While, in the exemplary embodiment, each of content generation logic 220, filtering logic 222, display logic 224, artist collaboration logic 230, one or more of filtering logic 222 and display logic 224, vector generation logic 232, standardization logic 234, rank logic 236, co-occurrence logic 238, control logic 252, communication logic 254, payment logic 256, and document generation logic 258 is depicted as part of artist collaboration platform 120, these logical components need not be so configured, and in other embodiments, other configurations of the various components, within content generation system 120 or distributed over one or more computing systems, are possible. Content generation logic 220, filtering logic 222, display logic 224, artist collaboration logic 230, one or more of filtering logic 222 and display logic 224, vector generation logic 232, standardization logic 234, rank logic 236, co-occurrence logic 238, control logic 252, communication logic 254, payment logic 256, and/or document generation logic 258 may be variously implemented in software, hardware, firmware or any combination thereof. In the exemplary artist collaboration platform 120 shown in FIG. 2, content generation logic 220, filtering logic 222, display logic 224, artist collaboration logic 230, one or more of filtering logic 222 and display logic 224, vector generation logic 232, standardization logic 234, rank logic 236, co-occurrence logic 238, control logic 252, communication logic 254, payment logic 256, and document generation logic 258 are implemented in software and are stored in memory 210 of the artist collaboration platform 120. Note that these components, when implemented in software, can be stored and transported on any non-transitory computer-readable medium for use by or in connection with an apparatus (e.g., a microprocessor) that can execute instructions. In the context of this disclosure, a “computer-readable medium” can be any device or system that can contain or store a computer program for use by or in connection with an instruction execution apparatus.

The logics of the exemplary artist collaboration platform 120 depicted in FIG. 2 may be executed by one or more conventional processing elements 260, such as one or more central processing units (CPU), digital signal processors (DSP), graphics processing units (GPU), application-specific integrated circuits (ASICs), field-programmable gate arrays (FPGAs), and/or microprocessors programmed with software or firmware, other specialized processor or combination of processors, or other circuitry that communicates to and drives the other elements within the content generation system 120 via a local interface 265, which can include at least one bus, such as I2C, SPI, USB, UART, and GPIO. As an example, the processor 260 may execute instructions of software stored in memory 210, such as content generation logic 220, filtering logic 222, display logic 224, artist collaboration logic 230, one or more of filtering logic 222 and display logic 224, vector generation logic 232, standardization logic 234, rank logic 236, co-occurrence logic 238, control logic 252, communication logic 254, payment logic 256, and/or document generation logic 258, or subsets thereof. While FIG. 2 illustrates one processor 260 which implements all of the various logics in the artist collaboration platform 120, it is possible in other embodiments for the artist collaboration platform 120 to employ multiple processors. In one such alternate embodiment, discrete processing elements may be used for each of (or any subset of) content generation logic 220, filtering logic 222, display logic 224, artist collaboration logic 230, one or more of filtering logic 222 and display logic 224, vector generation logic 232, standardization logic 234, rank logic 236, co-occurrence logic 238, control logic 252, communication logic 254, payment logic 256, and document generation logic 258, or any portions or subsets of those logics. In some embodiments, the processing of artist collaboration platform 120 is not limited to being performed by a processing element connected to the local interface 265, but instead, any portion of processing in support of the various logics of content generation logic 220 and/or artist collaboration content logic 230 may be distributed over one or more computer systems that may be remotely located. For instance, artist collaboration platform 120 may include physical computing devices residing at a particular location or may be deployed, wholly or partially, in a cloud computing network environment. In this description, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.). In some embodiments, the processor 260 may comprise an artificial neural network or other type of configuration for performing machine learning functions based on instructions stored in memory 210.

Memory 210 may be configured, in some embodiments, to include information stored in an artist database 240, as one or more of industry data 242, descriptive attribute data 244, rank data 246, and collaboration request data 248. In other embodiments, any or all of these components and/or information need not be stored on memory 210, but may instead be stored in a different memory and database, whether local artist collaboration platform 120 or on one or more remote servers (in some embodiments, in the cloud). The data in artist database 240 may be referenced in a manner discussed in greater detail below.

According to at least some embodiments, industry data 242 may include industry statistics for each artist (e.g., user/entity) interacting with artist collaboration platform 120. In this regard, artist collaboration platform can aggregate industry statistics for each artist within artist collaboration platform by ingesting data from a variety of sources that collect artist statistics, such as artist platforms 116-1, 116-2, . . . , 116-N. In another embodiment, the artist collaboration platform 120 can interact with an artist data aggregation platform 112 that aggregates artist industry statistics and provides the aggregated artist industry statistics to artist collaboration platform 120. In some embodiments, industry data 242 can include data such as such as subscribers, views, likes, comments, and engagement rate associated with an artist profile on Youtube™, monthly listeners, playlist reach, fan conversion rate, popularity, and followers associated with an artist profile on Spotify™, followers, views, likes comments, and engagement rates on TikTok™, followers, likes, comments, and engagement rate on Instagram™, followers on Twitter/X, and fans on Deezer.

Descriptive attribute data 244 can include a list of genres associated with each artist (e.g., user/entity) participating on artist collaboration platform 120. For example, artist database 240 can store a number of musical genres associated with a given artist, such as folk, jazz, hip hop, instrumental, heavy metal, etc. Descriptive attribute data 244 can also include other descriptive attributes associated with a given artist such as audience demographics. Audience demographics includes a list of characteristics associated with the listeners, fans, or followers of a given artist. Audience demographics can include, for example, audience location by country, audience gender, audience age bands, audience ethnicity, etc. According to some embodiments, descriptive attribute data 244 can also include co-occurrence data that is generated by co-occurrence logic 238 processing descriptive attribute data 244. In this regard, co-occurrence logic 238 can process descriptive attribute data 244 such that descriptive attribute data 244 can be vectorized and used by artist collaboration platform 120 to find optimal matches for artist collaboration. In some embodiments, co-occurrence logic 238 can process descriptive attribute data 244 in the following manner, using artist genre information as an example. For each artist that collaboration platform 120 is able to pull genre information for (e.g., either from one or more artist platforms 116 and/or from artist aggregation platform 116), co-occurrence logic 238 can construct a co-occurrence matrix with every identified genre (e.g., rock, pop, etc.) located on both the x and y axes of the matrix. In some embodiments, co-occurrence logic 238 computes the frequency of every pair of genres. In one example, if an artist is tagged with the genres pop, rock, and country, there would be matrix entries associated with the co-occurrence of pop with rock, pop with country, and rock with country. In this example, the co-occurrence of pop with rock, pop with country, and rock with country would be counted across all artist profiles within artist database 240. Co-occurrence logic 238 may determine the range of frequencies of genre co-occurrence. For example, certain genres (e.g., big band and heavy metal) may have a minimal number of co-occurrences, possibly zero, and other genres may co-occur relatively frequently, such as hip hop and rap. Based on the range of frequencies, co-occurrence logic 238 may assign a value to each genre-pair indicating the likelihood of the two given genres being used together to describe the genre of any given artist within artist collaboration platform 120. Co-occurrence logic 238 can populate the resultant genre matrix with co-occurrence likelihoods for each genre, where each artist can be represented as a vector in the co-occurrence genre matrix. For example, for an artist tagged with the genres pop, rock, and country, a vector could be created that is some logical combination (e.g., average) of the rows for pop, rock, and country in the genre co-occurrence matrix. In a similar manner, co-occurrence logic 238 can construct co-occurrence matrixes for every other descriptive attribute contained within descriptive attribute data 244, such as audience location by country, audience gender, audience age bands, audience ethnicity, etc. These co-occurrence matrixes can allow artist collaboration platform 120 to optimally match a first artist with a second artist based on similar descriptive attributes, such as having fans in a similar audience location or fans of a similar age range, and/or having closely related genres that co-occurrence logic 238 has determined co-occur frequently (e.g., hip hop and rap). It should be noted that the vector distances of the co-occurrence data is a measure of similarity. For example, the distance between age bands of an audience is a measure of similarity, and not a measure of a difference of age in a number of years.

According to some embodiments, rank logic 236 of artist collaboration platform 120 can assign ranks for each artist within artist collaboration platform 120. In other words, rank logic 236 can calculate rank data 246 based in part on industry data 242 that artist collaboration platform 120 pulls from artist platforms 116 and/or artist aggregation platforms 112. According to some embodiments, rank logic 236 can operate on at least Spotify monthly listeners, Tik Tok followers, Twitter followers, Instagram followers, YouTube subscribers, and/or Facebook fan entries within industry data 242 for each artist identified in artist database 240 to calculate rank data 246. In one embodiment, rank logic 236 of artist collaboration platform 120 can create bins based on precomputed levels for each of the aforementioned industry data 242. For example, an artist can be assigned a level or bin of 0 for having between 0 and 950 Spotify monthly listeners, a level or bin of 1 for having between 951 and 2700 Spotify monthly listeners, a level of 3 for having between 5,401 and 8,700 Spotify monthly listeners etc. It should be understood that the number of bins and the size of bins can be adjusted as desired. Bins can be assigned by rank logic 236 in a similar manner for each of Tik Tok followers, Twitter followers, Instagram followers, YouTube subscribers, and/or Facebook fan entries. Accordingly, rank logic 236 can create rank data 246 that have a clear ordering or ranking allowing artist collaboration platform 120 to reward artists for collaborating with artists having the same or a similar rank along a number of rank data 246 entries. Accordingly, in some embodiments, rank logic 236 of artist collaboration platform 120 seeks to match artists that have similar Spotify monthly listeners, Tik Tok followers, Twitter followers, Instagram followers, YouTube subscribers, and/or Facebook fan entries. It should be understood that rank logic 236 can process data or other types and that rank data 246 is not limited to Spotify monthly listeners, Tik Tok followers, Twitter followers, Instagram followers, YouTube subscribers, and/or Facebook fan entries.

According to some embodiments, the rank logic 236 can operate according to the following equation (1) in order to normalize rank data 246:

$${d}^{′} ( d ) = \frac{{e}^{a \vert d - 1 \vert} - 1}{{e}^{a M} - 1} \qquad ( 1 )$$

In equation (1), M represents the maximum possible absolute difference between the ranks of two artists, minus one. This difference, denoted as M, determines the range over which equation (1) will be applied and helps rank logic 236 to scale the result of equation (1) to lie between 0 and 1. The symbol d represents the difference in ranks between two artists (e.g., d=level 1-level 2). M represents the maximum absolute difference that the term (d−1) can have in equation (1). Thus, M helps normalize the exponential function of equation (1), thus ensuring that the rescaled distance d′(d) is always between 0 and 1 by dividing by the term e^{aM}−1. In other words, M sets the boundaries for the maximum possible distance in levels within equation (1).

Once rank logic 236 calculates the rank normalization according to equation (1), these rescaled rank distances may be used to calculate a rank data 246 component of the vector distance between any two given artists (a,b), as described below in more detail with respect to equation (2).

Filtering logic 222 of content generation logic 220 may filter search results provided by the artist collaboration platform 120 in response to a user (e.g., artist) search initiated via interaction with the artist collaboration platform 120. In one embodiment, an artist may interact with the artist collaboration platform 120 via a user device 102. The user may initiate a search for a collaborating artist by inputting one or more parameters as part of collaboration request data 248. Collaboration request data 248 may identify parameters that the requesting artist wants to emphasize in his or her own career. For example, in one embodiment, the collaboration request data 248 may include an indication of which component of his or her profile the artist wishes to enhance through the collaboration. In this regard, the artist's profile can be broken into at least three components. In some embodiments, the three components can be identified as the “career” component, “fortune” component, and “fame” component. Each of these components operates on the same data (e.g., data stored in artist database 240 stored as industry data 242, descriptive attribute data 244, and rank data 246) but may apply different weights for each of the data entries within the data or artist database 240, thereby changing the optimal match that artist collaboration platform 120 may identify between a given artist searching for another artist to collaborate with. The career component optimizes the match for optimizing an artist's career holistically and biases the recommendation for optimizing the artist's career holistically. The “fortune” component focuses on monetization opportunities and biases recommendations for collaborating artists that artist collaboration platform 120 can help increase the earning potential of a given artist. The “fame” component focuses on awareness opportunities and biases the recommendation for increasing the overall exposure of a given artist. In response to receiving collaboration request data 248 from a given artist (e.g., user/entity) via a user device 102, display logic 224 is configured to generate a display of optimal artist matches via a graphical user interface displayed on user device 102. According to some embodiments, the biases are represented by artist collaboration platform 120 by adjusting the weights assigned to the various components of the artist vector generated by vector generation logic 232, as discussed in more detail below.

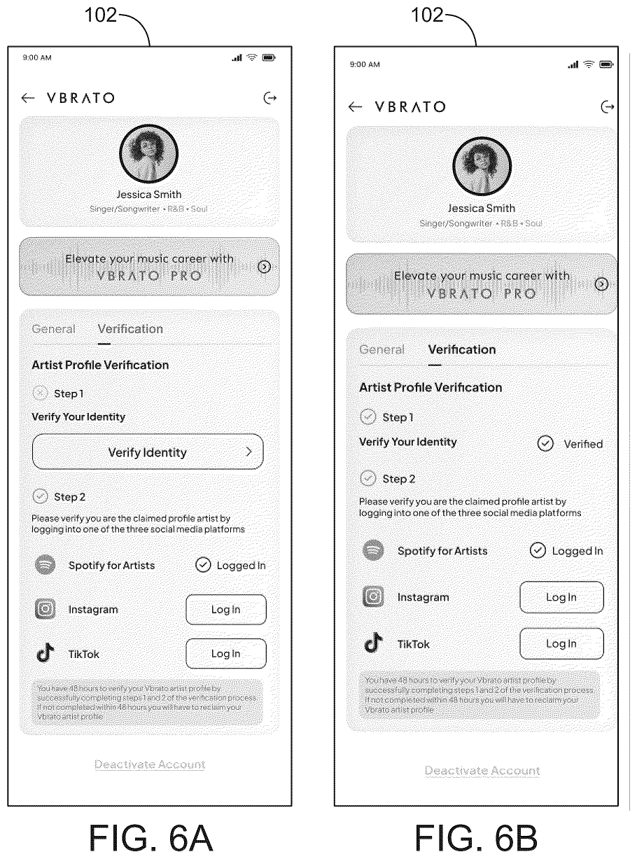

In some embodiments, collaboration request data 248 can also include specific collaboration criteria. In an embodiment, the collaboration request data 248 can include requirements such as a requirement for completing the collaboration submission before a specific date, specification on the type of submission (e.g., vocal collaboration including at least a first verse, a hook, etc.) a requirement to post a number of social media posts advertising the collaboration, etc. In an embodiment, the collaboration request data 248 can be used by filtering logic 222 and display logic of content generation logic 220 to filter through available artist profiles to find an optimal match between the requesting artist and a potential collaborating artist, as will be described in more detail with respect to FIGS. 6A-16B.

In some embodiments, control logic 252 and/or communication logic 254 are executed by processor 260 to provide a graphical user interface to be displayed on user device 102. Control logic 252 and/or communication logic 254 may present to the user device 102, a user interface through which an artist can input collaboration request data 248, select artist collaborator, set payment and ownership terms for a given collaboration, and review and accept a collaboration submission from a given artist collaborator, as will be described in more detail with respect to FIGS. 6A-16B.

According to some embodiments, industry data 242, descriptive attribute data 244, and/or rank data 246 can be normalized by standardization logic 234 of artist collaboration logic 230 of artist collaboration platform 120. In this regard, standardization logic 234 can apply normalization and/or standardization techniques to one or more of industry data 242, descriptive attribute data 244, and/or rank data 246 as these data entries are pulled from the artist platforms 116-1, 116-2, . . . , 116-N. In this way, the data entries comprising industry data 242, descriptive attribute data 244, and/or rank data 246 are standardized to an interoperable format that artist collaboration platform 120 can be used by respective vector generation logic 232, rank logic 236, and/or co-occurrence logic 238 of artist collaboration platform 120. In some embodiments, standardization logic 234 can apply one or more processing algorithms on the vectors generated by vector generation logic 232 to bring the vectors in scale with each other to allow for accurate comparison. That is, one or more feature scaling processes may be applied as a preprocessing step that assists in vector comparison. Such processing may include, for instance, subtraction of a mean value for mean normalization. In some embodiments, the processing may additionally or alternatively include division of the vectors by a standard deviation (e.g., z-scale normalization). Other embodiments also use other processes, such as min-max normalization, or any other known method of normalizing the variables of features in the vector data generated by vector generation logic 232.

Vector generation logic 232 is configured to vectorize the data stored in artist database 240 including but not limited to industry data 242, descriptive attribute data 244, rank data 246, and/or collaboration request data. According to an embodiment, vector generation logic 232 can calculate a vector for each artist for which data is available within artist database 240. In some embodiments, vector generation logic 232 can also be configured to generate a distance between each vector representing a given artist and all other artists for which vector generation logic 232 calculates an artist vector. Vector generation logic 232 can calculate vector distances using a suitable algorithm, including but not limited to computing a Euclidean distance, a Minkowski distance, a Manhattan distance, and/or a Chebyshev distance.

According to some embodiments, vector generation logic 232 can determine the distance between two artist vectors according to the equation (2):

$$d ( a , b ) = \sqrt{{w}_{1} {( {a}_{1} - {b}_{1} )}^{2} + {{w}_{2} ( {a}_{2} - {b}_{2} )}^{2} + ... {{w}_{n} ( {a}_{n} - {b}_{n} )}^{2}} \qquad ( 2 )$$

In equation (2), d(a, b) stands for the distance between vector (a) associated with a first artist and vector (b) associated with a second artist, wₙ stands for a weight associated with the nth vector dimension, and an, bn stand for the values of each component of vector (a) and vector (b), respectively. According to some embodiments, vector logic 232 selects the weights wₙ for each component based in part on the component that the artist wishes to maximize (e.g., career, fortune, or fame, otherwise referred to as an “intersection bias”). In this regard, artist collaboration platform 120 adjusts weights of components higher for dimensions that an artist wants to magnify according to the component area strategy that the artist wants to emphasize (e.g., career, fortune, and/or fame).

In certain embodiments, vector logic 232 and/or standardization logic 234 can further rescale the distance between two artist vectors as determined in equation (2) according to equations (3) and (4):

$$s = 1000 * \frac{( d ( a , b ) - {d}_{min} )}{{d}_{max} - {d}_{min}} \qquad ( 3 )$$

$$final score = 1000 - s \qquad ( 4 )$$

In equation (3), dₘᵢₙ stands for a minimum vector distance between any artist pair (a,b), and dₘₐₓ stands for a maximum vector distance between any artist pair (a,b). Once s is calculated, the final score is determined based on subtracting s from 1000 in order to signify that higher scores indicate a more desirable outcome. However, it should be understood that in various embodiments, a lower score may indicate a more desirable match, and accordingly a final score may be calculated according to equation to without the use of equation (4). Additionally, other methods of calculating a distance between two artists are presumed to be within the scope of the present disclosure.

Payment logic 256 is configured to provide payment processing services to users of artist collaboration platform 120. For example, an artist wishing to pay for a collaboration with another artist may interact with payment logic 256. In some embodiments, payment logic 256 can be configured to interact with an external payment processor (e.g., payment processor 110) that provides payment processing on behalf of artist collaboration platform 120. In some embodiments, payment logic 256 can provide some or all of the services associated with payment processor 110 without relying on an external payment processor 110. In some embodiments, payment logic 256 can be configured to hold payments in escrow until a condition is met (e.g., until a requesting artist provides an input to artist collaboration platform 120 indicating that a collaborating artist has met one or more collaboration requirements set by the requesting artist). In this way, payment logic 256 is programmed to ensure that an artist requesting a collaboration receives a satisfactory collaboration from the collaborating artists before payments are remitted to the collaborating artist.

Document generation logic 258 is configured with natural language processing capabilities in order to summarize the terms of an accepted collaboration between a requesting artist and a collaborating artist. In some embodiments, document generation logic 258 is configured to automatically generate a legal document that includes terms surrounding ownership, distribution rights, and profit share terms regarding the master recording, publishing rights, etc. Once a collaboration is completed, document generation logic 258 can generate a legal document based on the agreed upon terms of the collaboration. The generated legal document can be stored by artist collaboration platform 120 on artist database 240.

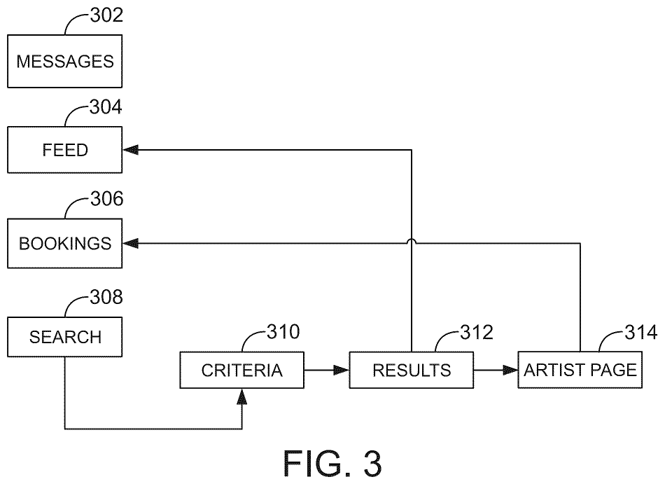

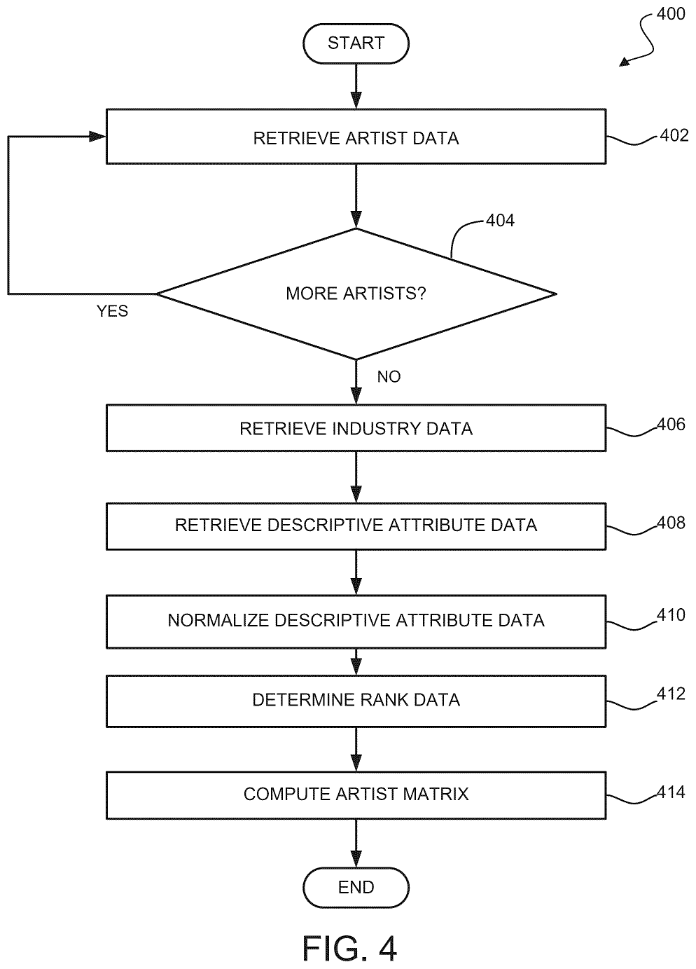

FIG. 3 is an exemplary flowchart representing various functionalities of the artist collaboration platform 120. As shown, artist collaboration platform 120 can include messages 302, feed 304, bookings 306, search 308, criteria 310, results 312, and artist page 314. An artist using artist collaboration platform 120 (e.g., via user device 102-1) can employ a search 308 and specify one or more search criteria 310 (e.g., looking for a hip hop vocalist with a minimum of 10,000 Tik Tok followers). In response, the filtering logic 222 filters existing artists within the artist collaboration platform based on the one or more search criteria 310 and display logic 224 causes user device 102-1 to display the results fitting the one or more search criteria 310. The search results 312 can include one or more artist pages 314 that the artist can interact with in order to initiate a booking 306. The artist can send one or more messages 302 to an artist page 314 in order to negotiate the terms of the proposed booking 306. In some embodiments, the artist collaboration platform 120 can generate a feed 304 that includes open (e.g., unfilled) bookings 306 that is provided to the artist for display. In some embodiments, if a first requesting artist (e.g., a user of user device 102-1) has initiated a search and a second artist (e.g., a user of user device 102-2) has been identified as a potential optimal match, the artist collaboration platform 120 can include the profile of the first requesting artist (including any active/open collaboration requests of the first artist) within the feed 304 of the second artist. According to some embodiments, artist collaboration platform 120 may enable various types of searches. First, limiting example, an artist using artist collaboration platform may perform an “curiosity search” in which a first artist seeks a second artist without specifying a specific collaboration project. In this example, a first artist may wish to familiarize themselves with other artists and creatives using artist collaboration 120 without specifying a particular project that the first artist is seeking a collaborator for. Another type of search enabled by artist collaboration platform can be referred to as a “collaborator search.” In this regard, a first artist may additionally specify a particular collaboration project with collaboration parameters for which the first artist is seeking a collaborating artist (e.g. a second artist). In such examples, the vector distance quantified by equation (2) may be modified with additional dimensions having respective weights responding to the various parameters of the specific collaboration requested by the first artist. In such a way the first artist may bias the vector distances between other artists in the first artist based on the specific parameters that the first artist selects for the collaboration project. For example, in a curiosity search the first artist may be matched to a particular set artist based on similarities in fan base, demographics, genre etc. However, in a collaborator search, the first artist may be matched to a different artist (e.g., a third artist) that may not match as closely as the second artist to the first artist but fits the specific collaboration criteria specified by the first artist for a particular collaboration. FIG. 4 is an exemplary flowchart of a process of computing an artist matrix in accordance with some embodiments of the present disclosure. In step 402, the method can include retrieving artist data. Artist data can be retrieved from one or more artist platform 116-1, 116-2, . . . 116-N. In some embodiments, artist data can be retrieved from an artist aggregation platform 112. As discussed above, artist data can include industry data 242 and descriptive attribute data 244. In decision block 404, the method can include determining whether there are more artists with artist data for artist collaboration platform 120 to retrieve. If there is more artist data to retrieve, the method returns to block 402. If no more artist data is available to be retrieved, the method moves to block 406.

In block 406, the method may include retrieving industry data. Artist collaboration platform 120 can be configured to identify industry data from all artist data that is collected from the artist platforms 116-1, 116-2, . . . , 116-N.

In block 408, the method can include retrieving descriptive attribute data. Artist collaboration platform 120 can be configured to identify descriptive attribute data from all artist data that is collected from the artist platforms 116-1, 116-2, . . . , 116-N.

In block 410, the method can include normalize the descriptive attribute data. In this regard, co-occurrence logic 238 may be configured to process the descriptive attribute data using co-occurrence analysis to convert the descriptive data into data that can be used by vector generation logic 232 to generate artist vectors.

In block 412, the method can include determining rank data. As discussed above with respect to FIG. 2, rank logic 236 of artist collaboration platform 120 can assign ranks for each artist within artist collaboration platform 120. In other words, rank logic 236 can calculate rank data 246 based in part on industry data 242 that artist collaboration platform 120 pulls from artist platforms 116 and/or artist aggregation platforms 112. According to some embodiments, rank logic 236 can operate on at least Spotify monthly listeners, Tik Tok followers, Twitter followers, Instagram followers, YouTube subscribers, and/or Facebook fan entries within industry data 242 for each artist identified in artist database 240 to calculate rank data 246. In one embodiment, rank logic 236 of artist collaboration platform 120 can create bins based on precomputed levels for each of the aforementioned industry data 242. For example, an artist can be assigned a level or bin of 0 for having between 0 and 950 Spotify monthly listeners, a level or bin of 1 for having between 951 and 2700 Spotify monthly listeners, a level of 3 for having between 5,401 and 8,700 Spotify monthly listeners etc. It should be understood that the number of bins and the size of bins can be adjusted as desired. Bins can be assigned by rank logic 236 in a similar manner for each of Tik Tok followers, Twitter followers, Instagram followers, YouTube subscribers, and/or Facebook fan entries. Accordingly, rank logic 236 can create rank data 246 that have a clear ordering or ranking allowing artist collaboration platform 120 to reward artists for collaborating with artists having the same or a similar rank along a number of rank data 246 entries. In block 414, the method can include computing an artist matrix. The artist matrix is determined as the vector distance between each artist vector. Each cell on the artist matrix is the vector distance between the respective pair of artists. In some embodiments, the vector distance can be determined based on Equation (2), provided above. According to some embodiments, vector generation logic 232 can generate each artist vector based on the normalized descriptive attribute data, the industry data, and the rank data. After each artist vector is generated, the distance between each artist and every other artist is determined in a pairwise fashion, and each vector distance becomes an entry into a respective cell of the artist matrix. According to some embodiments, there can be a plurality of artist matrixes, depending on the number of intersection biases present within artist collaboration platform 120. In one embodiment, there are three intersection biases within artist collaboration platform 120 (e.g., career, fortune, and fame). For each intersection bias, the artist vector is altered based on vector generation logic 232 assigning different weights (wₙ) for each vector dimension depending on the selected intersection bias. Accordingly, in some embodiments, there may be several artist matrices that are based on the number of intersection biases present within artist collaboration platform 120.

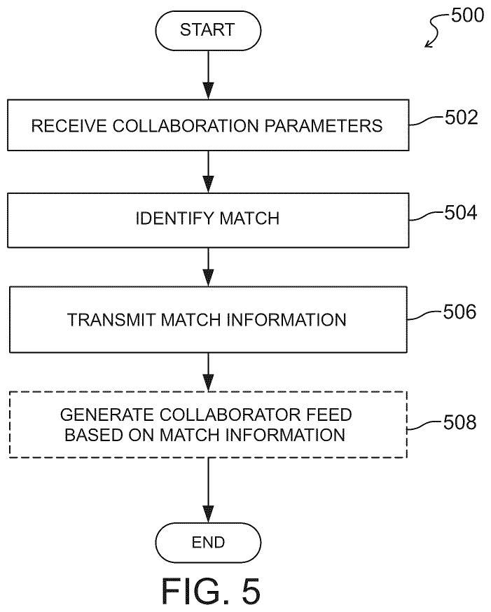

FIG. 5 is an exemplary flowchart of a process of identifying a collaboration match in accordance with some embodiments of the present disclosure. In block 502, the method can include receiving collaboration parameters from an artist seeking a collaborator. For example, a first artist associated with a first user device (e.g., user device 102-1) may provide a number of collaboration parameters, such as genre, number of social media followers, musical instrument, etc. to artist collaboration platform 120 that may be used in combination with artist vector generated by vector generation logic 232 to determine an optimal collaborator for the first artist. In block 504, the method can include identifying a match. The match can be based on determining one or more second artists that have a minimized vector distance to the requesting artist vector and that match the collaboration parameters provided by the requesting artist. In block 506, the method can include transmitting match information to the user device (e.g., user device 102-1) of the requesting artist. In this regard, display logic 224 can cause a graphical user interface to be displayed on user device 102-1 listing one or more second artist profiles that are associated with the matches determined in block 504. In optional block 508, the method can include generating a collaborator feed based on the match information. For example, a feed that includes an artist profile of the requesting artist can be provided to one or more of the artists identified as matches in block 504. In this way, artists looking to collaborate with others can be provided with artist profiles that are seeking collaborators for which they are “prequalified” based on having a small/minimal vector distance to the requesting artist. The feed then allows artists to directly contact artists that show on the feed and submit collaboration submissions that may be considered by the requesting artist, even if not directly selected by the requesting artist in blocks 504-506.

FIGS. 6A-16B show exemplary graphical user interfaces produced by artist collaboration platform, according to various embodiments of the present disclosure. The graphical user interfaces can be generated by artist collaboration platform 120 (e.g., via content generation logic 220) and be displayed on a user device (e.g., one of a user device 102-1, 102-2, . . . , 102-N) associated with a respective artist. As shown in FIGS. 6A-6B a user device 102 can be presented with a graphical user interface that allows an artist to register an account with artist collaboration platform 120. The artist collaboration platform 120 can allow a user to verify his or her identity. Identify can be verified in a number of ways. For example, the user may be asked to upload a copy of a government issued identification. In other embodiments, identity verification can be handled by a third party identity verification service. After verification, an artist can be asked to log into one or more artist platforms 116. As shown in FIGS. 6A and 6B, the artist is asked to log in to Spotify (e.g., artist platform 116-1), Instagram (e.g., artist platform 116-2), and TikTok (e.g., artist platform 116-3). It should be understood that artist collaboration platform can ingest information from any number of artist platforms 116, and is not limited as shown.

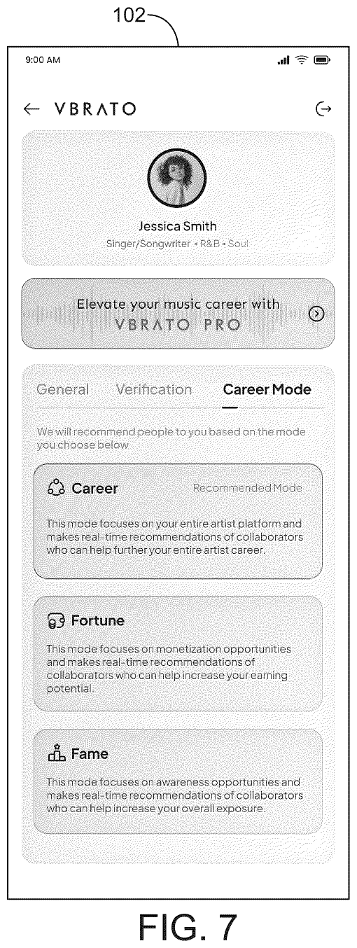

FIG. 7 shows a graphical user interface that can be shown to a user following verification, according to an embodiment consistent with the present disclosure. As shown, the artist can be asked to choose one of a plurality of components to focus on (e.g., an intersection bias), and in response the artist collaboration platform 120 can select appropriate weights (e.g., wₙ) for each component of the artist vector to bias the value of each component of the artist vector as desired. In this way, artist collaboration platform 120 can optimize the matching algorithm depending on the desires of the user to maximize income generation, exposure, or a combination of both.

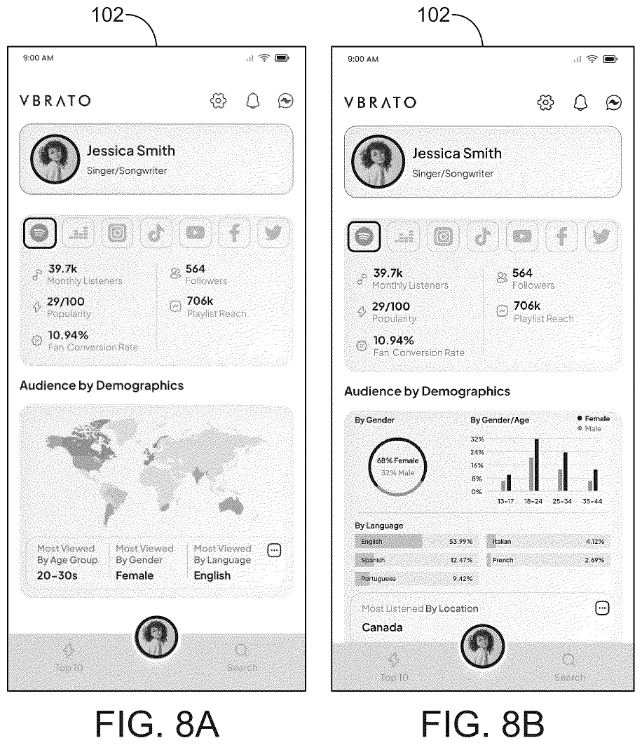

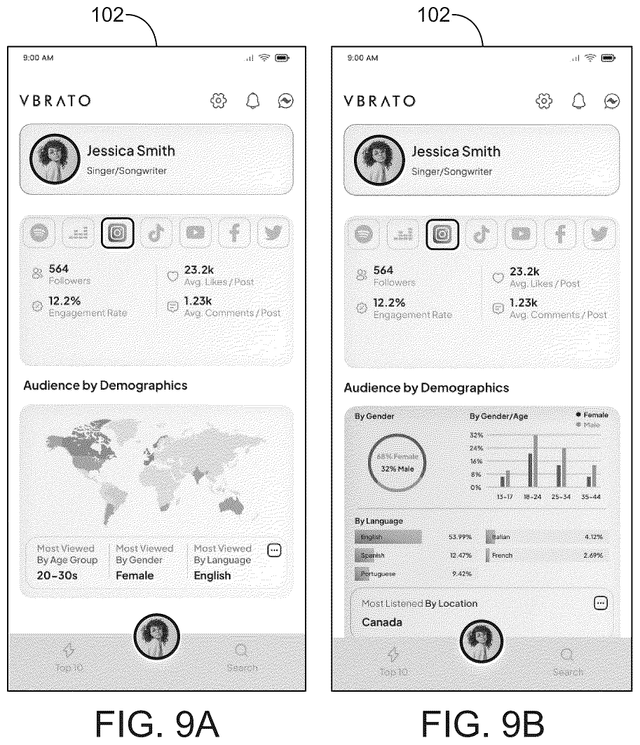

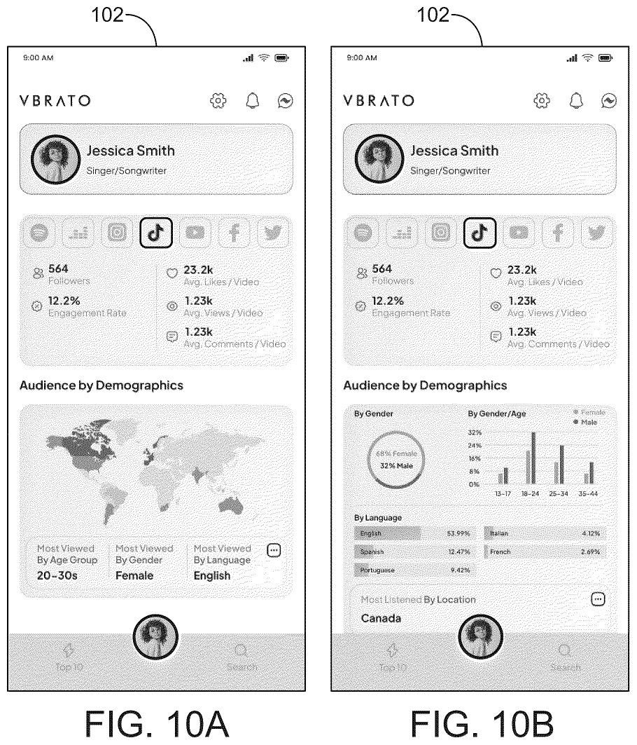

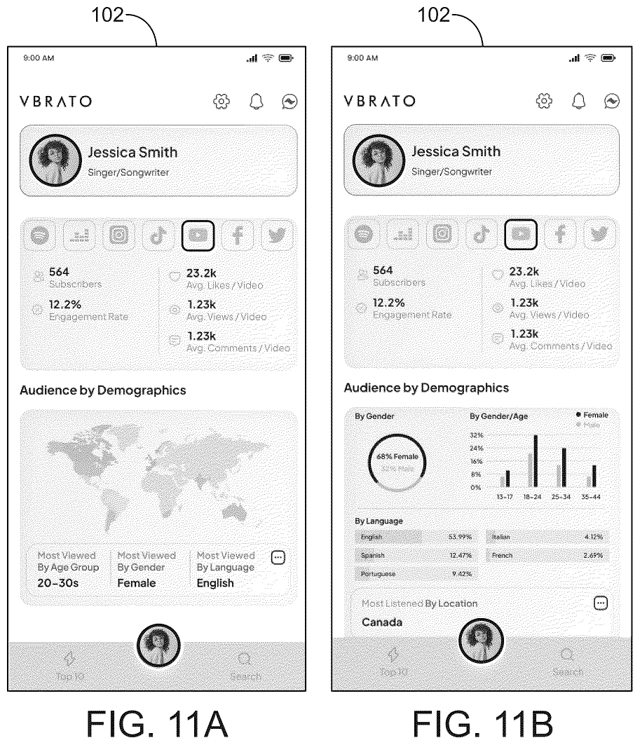

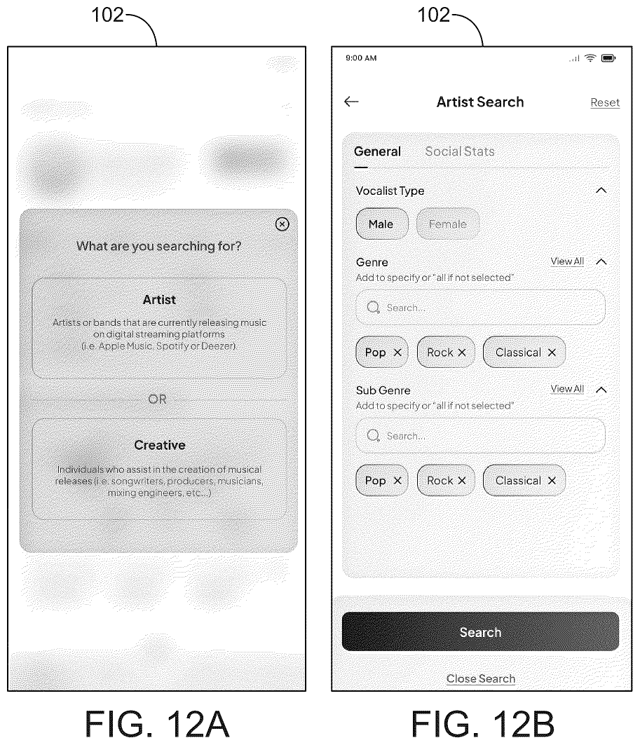

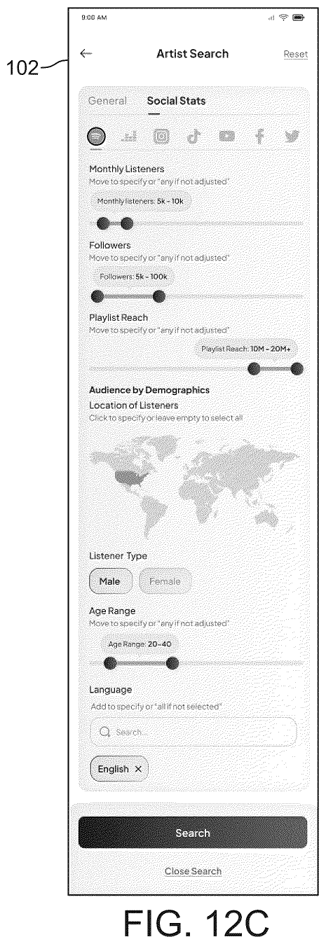

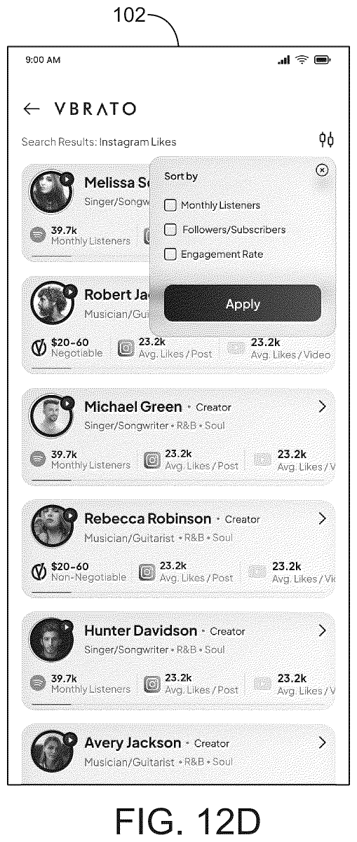

FIGS. 8A-11B shows industry statistics (e.g., industry data 242) from a variety of artist platforms 116 for a particular artist. In this regard, FIGS. 8A-8B show industry statistics pulled from Spotify (e.g., artist platform 116-1), FIGS. 9A-9B shows industry statistics pulled from Instagram (e.g., artist platform 116-2), FIGS. 10A-10B shows industry statistics pulled from TikTok (e.g., artist platform 116-3), and FIGS. 11A-11B shows industry statistics pulled from YouTube (e.g., artist platform 116-4). It should be understood that industry statistics can include, but not be limited to data such as such as subscribers, views, likes, comments, and engagement rate associated with an artist profile on Youtube™, monthly listeners, playlist reach, fan conversion rate, popularity, and followers associated with an artist profile on Spotify™, followers, views, likes comments, and engagement rates on TikTok™, followers, likes, comments, and engagement rate on Instagram™, followers on Twitter/X, and fans on Deezer. In this embodiment, FIGS. 8A-11B show various industry statistics for artist Jessica Smith. FIGS. 12A-12C show an artist search for a collaborator and FIG. 12D shows results of the collaborator search, according to an embodiment consistent with the disclosure. In FIG. 12A, the artist can select what type of collaborator the artist is looking for. In the example shown, the artist (e.g., user/entity) can select a search for another artist (e.g., musician) or a creative (e.g., producer). It should be understood that the present embodiments are not limited to matching artists with each other, but can also match any type of creative with one another. After selecting the type of collaboration search, the artist can be brought to the graphical user interface shown in FIG. 12B. In the example shown in FIG. 12B, the artist has selected a search for another artist, and is able to select the type of artist he or she is looking for. In the example shown, the artist has selected a search for a vocalist, and is further able to add genres to further specify the search criteria. In FIG. 12C, the artist is able to further add additional collaboration parameters (e.g., collaboration request data 248) such as social media requirements for the collaborative artist. In the example shown in FIG. 12C, the artist can specify that the artist search be limited to artist that have between 5,000 and 10,000 monthly listeners on Spotify, have between 5,000 and 100,000 followers on Spotify, have a playlist reach between 10,000,000 and 20,000,000+, have listeners primarily in the United States and that are primarily male, have an average age range between 20 and 40 years old, and primarily speak English. In response to the search parameters specified in FIGS. 12A-12C, FIG. 12D provides search results that meet the collaboration criteria specified by the artist. In some embodiments, the search results provided in FIG. 12D were calculated by the artist collaboration platform by identifying a number of artists that fit the collaboration criteria (e.g., collaboration request data 248) and that have a minimized vector distance between the collaborator artist vector and the requesting artist vector, as determined by vector generation logic 232 of artist collaboration logic 230. It should be noted that according to the embodiment shown in FIG. 12D, the requesting artist can choose one of a number of filters to sort the results by. For example, as currently shown, the results are filtered in order of Instagram likes, but could similarly be shown in order of Monthly listeners, followers/subscribers, and/or engagement rate.

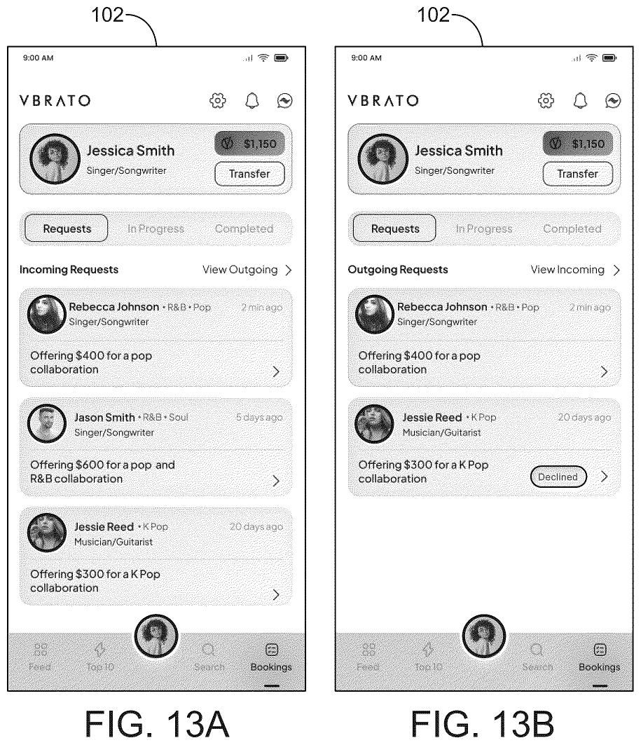

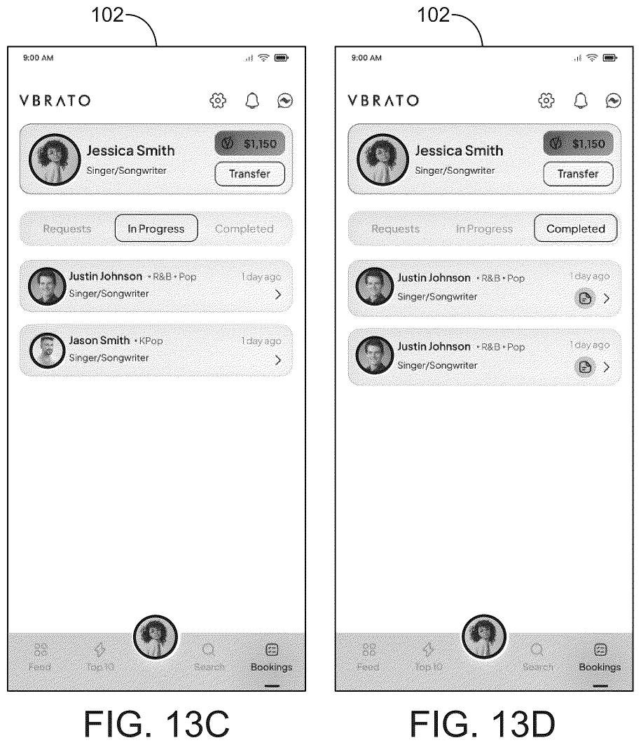

FIGS. 13A-13B shows exemplary incoming and outgoing bookings (e.g., bookings 306) for an example artist Jessica Smith. More specifically, FIG. 13A shows incoming bookings for Jessica Smith (e.g., potential collaborators offering collaboration requests to Jessica Smith) and FIG. 13B shows collaboration requests that Jessica Smith has sent other artists through artist collaboration platform 120. It should be noted that the bookings/requests shown in FIG. 13A and FIG. 13B have not been accepted.

FIGS. 13C shows in progress incoming collaborations for artist Jessica Smith. In this example, once all requirements for the collaboration (e.g., collaboration parameters associated with collaboration request data 248) are complete, artist Jessica Smith can provide an indication to artist collaboration platform 120 that all collaboration parameters have been met, and the artist collaboration platform will update the status of the respective collaboration to “complete” as shown in FIG. 13D.

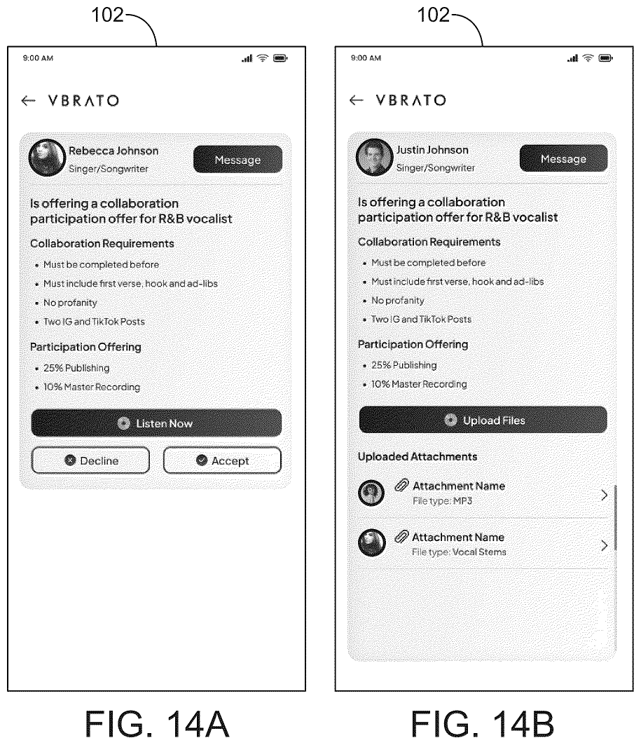

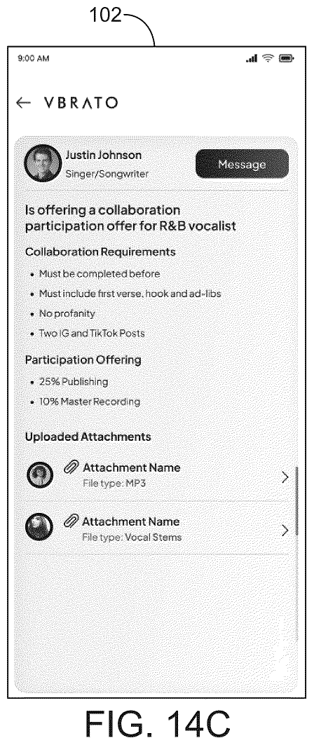

FIGS. 14A-14C shows example bookings in more details. For example, in FIG. 14A, an exemplary artist Rebecca Johnson is sending an incoming collaboration offering to be an R&B vocalist. The graphical user interface includes the collaboration parameters (e.g., when the collaboration must be completed, what the collaboration should include, and social media inputs required from the collaborator Rebecca Johnson). The graphical user interface also includes the ownership terms set by the requesting artist. In this example, the requesting artist is offering 25% of the publishing rights and 10% of the master recording rights to the collaborator Rebecca Johnson. The graphical user interface allows the requesting artist to send a message (e.g., a message 302) to the collaborator. The graphical user interface also includes a button “listen now” that allows the user to listen to the submission in response to the artist's collaboration request. If the requesting artist is satisfied with the collaboration submission, the requesting artist can click, tap, or otherwise interact with the “accept” button. Otherwise, if the collaboration is not satisfactory for any reason, the requesting artist can interact with the “decline” button. FIGS. 14B-14C shows booking details from the perspective of a collaborating artist. As shown in FIGS. 14B-14C, the collaborating artist is shown the same ownership terms set by the requesting artist. In this example, the requesting artist is offering 25% of the publishing rights and 10% of the master recording rights. The graphical user interface also allows the collaborating artist to upload files that include the collaboration sample (in this example, an R&B vocalist sample).

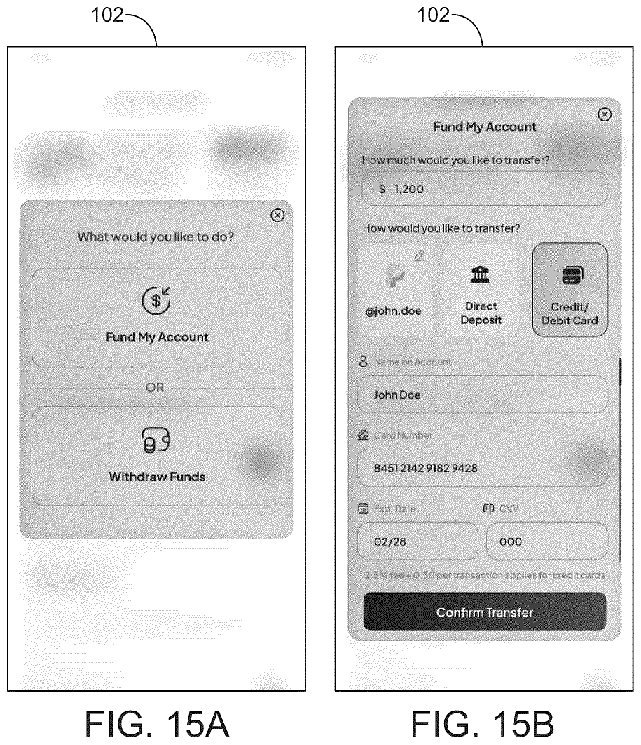

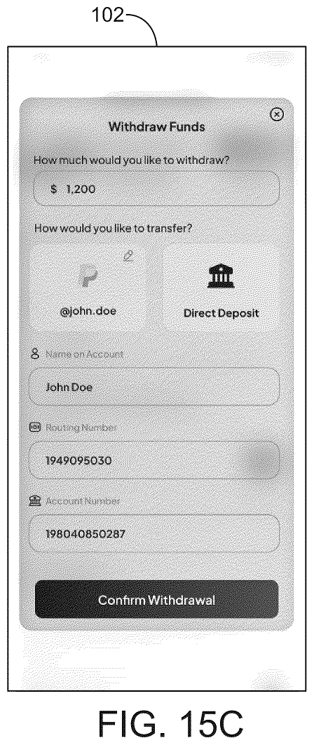

FIGS. 15A-15C shows exemplary graphical user interfaces that allow an artist to either withdraw or deposit funds with the artist collaboration platform 120. In this regard, the payment logic 256 of artist collaboration platform 120 is able to process requests to withdraw or deposit funds into an account associated with artist collaboration platform 120. In some embodiments, the payment logic 256 allows the user to withdraw or deposit funds through a payment processor 110 that is associated with, but separate from the artist collaboration platform 120. In FIG. 15A, an artist selects whether he or she wishes to withdraw or deposit funds into the artist collaboration platform 120. In the example shown in FIG. 15B, the artist has selected the “fund my account” option from FIG. 15A, and enters his or her funding information. In the example shown in FIG. 15C, the artist has selected the “withdraw funds” option from FIG. 15A, and confirms the amount to withdraw, and the banking information to which the funds are being withdrawn.

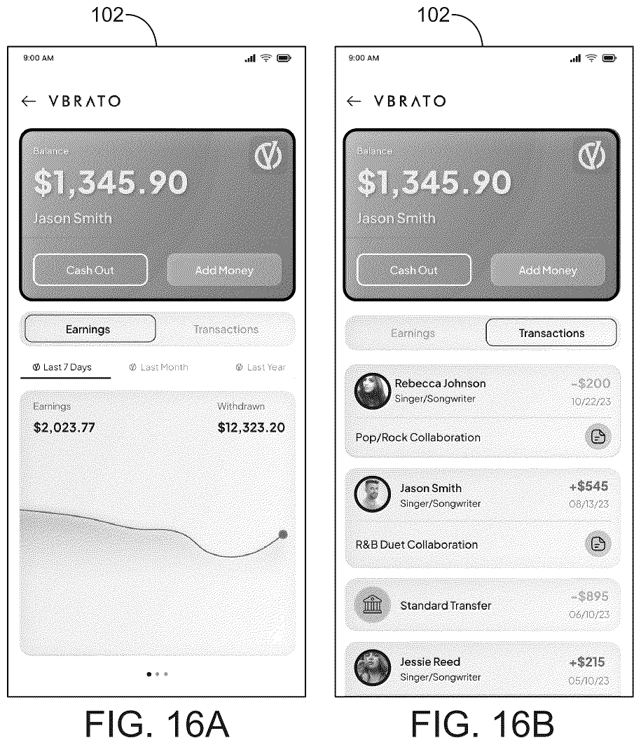

FIGS. 16A-16B shows a funds account associated with artist collaboration platform. More specifically, FIG. 16A shows the balance of an artist “Jason Smith” with a balance of $1,345.90. The graphical user interface allows Jason Smith to withdraw by interacting with the icon “Cash Out” or add additional funds from an external account by interacting with the icon “Add Money.” Additionally, under the “Earnings” tab, the artist is able to see earnings made through the artist collaboration platform 120. By interacting with the “Transactions” tab, as shown in FIG. 16B, the artist can view the transactions, both incoming and outgoing, for completed collaborations.

The disclosed embodiments can be implemented at least according to the following clauses:

Clause 1: A system comprising: one or more processors; and a non-transitory memory coupled to the one or more processors, and storing instructions, that when executed by the one or more processors are configured to cause the system to: receive entity data associated with a plurality of entities, the entity data comprising quantitative data and descriptive attribute data; computing one or more vectors based on the entity data for each entity of the plurality of entities; for each entity intersection of the plurality of entities, computing a vector distance; receive, from a first user device associated with a first entity, a match request; identify one or more second entities based on the match request and the computed vector distances associated with an intersection between the first entity and each complementary entity of the plurality of entities; and transmit, to the first user device, an indication of the one or more second entities.

Clause 2: The system of clause 1, wherein the non-transitory memory comprises further instructions, that when executed by the one or more processors, are configured to cause the system to: based on the match request and the computed vector distances, transmit to a second user device associated with a second entity of the one or more second entities an indication comprising a preliminary match with the first entity.

Clause 3: The system of clause 1, wherein: the match request comprises a selection of an intersection bias of a plurality of intersection biases; each entity intersection comprises a plurality of dimensions each corresponding to a weight; and the weight is determined based on the selection of the intersection bias.

Clause 4: The system of clause 1, wherein each entity intersection comprises a plurality of dimensions each corresponding to a weight and the non-transitory memory comprises further instructions, that when executed by the one or more processors, are configured to cause the system to: select an intersection bias of a plurality of intersection biases for the match request based on entity data associated with the first entity; and assign a weight to each dimension of the plurality of dimensions based on the selected intersection bias.

Clause 5: The system of clause 1, wherein: each entity intersection comprises a plurality of dimensions each corresponding to a weight; and computing a component of the vector distance associated with the descriptive data comprises computing a co-occurrence of dimensions of the descriptive data between the first entity and each complementary entity of the plurality of entities.

Clause 6: The system of clause 1, wherein: each vector of the one or more vectors comprises a plurality of dimensions corresponding to components of the entity data; and computing a component of the vector distance associated with the quantitative data comprises computing an ordinal rank for each dimension of the plurality of dimensions associated with the quantitative data.

Clause 7: The system of clause 1, wherein: each vector of the one or more vectors comprises a plurality of dimensions corresponding to components of the entity data; and computing a component of the vector distance associated with the quantitative data comprises normalizing the plurality of dimensions associated with the quantitative data.

Clause 8: The system of clause 7, wherein normalizing the plurality of dimensions associated with the quantitative data comprises a method selected from min-max scaling and decimal scaling.

Clause 9: The system of clause 1, wherein computing the vector distance comprises a method selected from computing a Euclidean distance, a Minkowski distance, a Manhattan distance, and a Chebyshev distance.

Clause 10: The system of clause 1, wherein identifying the one or more second entities further comprises selecting the one or more second entities associated with minimized vector distances.

Clause 11: A system comprising: one or more processors; and a non-transitory memory coupled to the one or more processors, and storing instructions, that when executed by the one or more processors are configured to cause the system to: receive entity data associated with a plurality of entities, the entity data comprising quantitative data and descriptive attribute data; computing one or more vectors based on the entity data for each entity of the plurality of entities; for each entity intersection of the plurality of entities, computing a vector distance; receive, from a first user device associated with a first entity, a match request; identify one or more second entities based on the match request and the computed vector distances associated with an intersection between the first entity and each complementary entity of the plurality of entities; based on the match request and the computed vector distances, transmit to a second user device associated with a second entity of the one or more second entities an indication comprising a preliminary match with the first entity.

Clause 12: The system of clause 11, the non-transitory memory comprises further instructions, that when executed by the one or more processors, are configured to cause the system to transmit to the first user device, an indication of the one or more second entities.

Clause 13: The system of clause 11, wherein: the match request comprises a selection of an intersection bias of a plurality of intersection biases; each entity intersection comprises a plurality of dimensions each corresponding to a weight; and the weight is determined based on the selection of the intersection bias.

Clause 14: The system of clause 11, wherein each entity intersection comprises a plurality of dimensions each corresponding to a weight and the non-transitory memory comprises further instructions, that when executed by the one or more processors, are configured to cause the system to: select an intersection bias of a plurality of intersection biases for the match request based on entity data associated with the first entity; and assign a weight to each dimension of the plurality of dimensions based on the selected intersection bias.

Clause 15: The system of clause 11, wherein: each entity intersection comprises a plurality of dimensions each corresponding to a weight; and computing a component of the vector distance associated with the descriptive data comprises computing a co-occurrence of dimensions of the descriptive data between the first entity and each complementary entity of the plurality of entities.

Clause 16: The system of clause 11, wherein: each vector of the one or more vectors comprises a plurality of dimensions corresponding to components of the entity data; and computing a component of the vector distance associated with the quantitative data comprises computing an ordinal rank for each dimension of the plurality of dimensions associated with the quantitative data.

Clause 17: The system of clause 11, wherein: each vector of the one or more vectors comprises a plurality of dimensions corresponding to components of the entity data; and computing a component of the vector distance associated with the quantitative data comprises normalizing the plurality of dimensions associated with the quantitative data.

Clause 18: The system of clause 17, wherein normalizing the plurality of dimensions associated with the quantitative data comprises a method selected from min-max scaling and decimal scaling.

Clause 19: The system of clause 11, wherein computing the vector distance comprises a method selected from computing a Euclidean distance, a Minkowski distance, a Manhattan distance, and a Chebyshev distance.

Clause 20: The system of clause 11, wherein identifying the one or more second entities further comprises selecting the one or more second entities associated with minimized vector distances.

The foregoing is merely illustrative of the principles of this disclosure and various modifications may be made by those skilled in the art without departing from the scope of this disclosure. The above described embodiments are presented for purposes of illustration and not of limitation. The present disclosure also can take many forms other than those explicitly described herein. Accordingly, it is emphasized that this disclosure is not limited to the explicitly disclosed methods, systems, and apparatuses, but is intended to include variations to and modifications thereof, which are within the spirit of the following claims.

As a further example, variations of apparatus or process parameters (e.g., dimensions, configurations, components, process step order, etc.) may be made to further optimize the provided structures, devices and methods, as shown and described herein. In any event, the structures and devices, as well as the associated methods, described herein have many applications. Therefore, the disclosed subject matter should not be limited to any single embodiment described herein, but rather should be construed in breadth and scope in accordance with the appended claims.

What is claimed is:

1. A system comprising:
one or more processors; and
a non-transitory memory coupled to the one or more processors, and storing instructions, that when executed by the one or more processors are configured to cause the system to:
receive entity data associated with a plurality of entities, the entity data comprising quantitative data and descriptive attribute data;
computing one or more vectors based on the entity data for each entity of the plurality of entities;
for each entity intersection of the plurality of entities, computing a vector distance;
receive, from a first user device associated with a first entity, a match request;
identify one or more second entities based on the match request and the computed vector distances associated with an intersection between the first entity and each complementary entity of the plurality of entities; and
transmit, to the first user device, an indication of the one or more second entities.

2. The system of claim 1, wherein the non-transitory memory comprises further instructions, that when executed by the one or more processors, are configured to cause the system to:
based on the match request and the computed vector distances, transmit to a second user device associated with a second entity of the one or more second entities an indication comprising a preliminary match with the first entity.

3. The system of claim 1, wherein:
the match request comprises a selection of an intersection bias of a plurality of intersection biases;
each entity intersection comprises a plurality of dimensions each corresponding to a weight; and
the weight is determined based on the selection of the intersection bias.

4. The system of claim 1, wherein each entity intersection comprises a plurality of dimensions each corresponding to a weight and the non-transitory memory comprises further instructions, that when executed by the one or more processors, are configured to cause the system to:
select an intersection bias of a plurality of intersection biases for the match request based on entity data associated with the first entity; and
assign a weight to each dimension of the plurality of dimensions based on the selected intersection bias.

5. The system of claim 1, wherein:
each entity intersection comprises a plurality of dimensions each corresponding to a weight; and
computing a component of the vector distance associated with the descriptive data comprises computing a co-occurrence of dimensions of the descriptive data between the first entity and each complementary entity of the plurality of entities.

6. The system of claim 1, wherein:
each vector of the one or more vectors comprises a plurality of dimensions corresponding to components of the entity data; and
computing a component of the vector distance associated with the quantitative data comprises computing an ordinal rank for each dimension of the plurality of dimensions associated with the quantitative data.

7. The system of claim 1, wherein:
each vector of the one or more vectors comprises a plurality of dimensions corresponding to components of the entity data; and
computing a component of the vector distance associated with the quantitative data comprises normalizing the plurality of dimensions associated with the quantitative data.

8. The system of claim 7, wherein normalizing the plurality of dimensions associated with the quantitative data comprises a method selected from min-max scaling and decimal scaling.

9. The system of claim 1, wherein computing the vector distance comprises a method selected from computing a Euclidean distance, a Minkowski distance, a Manhattan distance, and a Chebyshev distance.

10. The system of claim 1, wherein identifying the one or more second entities further comprises selecting the one or more second entities associated with minimized vector distances.

11. A system comprising:
one or more processors; and
a non-transitory memory coupled to the one or more processors, and storing instructions, that when executed by the one or more processors are configured to cause the system to:
receive entity data associated with a plurality of entities, the entity data comprising quantitative data and descriptive attribute data;
computing one or more vectors based on the entity data for each entity of the plurality of entities;
for each entity intersection of the plurality of entities, computing a vector distance;
receive, from a first user device associated with a first entity, a match request;
identify one or more second entities based on the match request and the computed vector distances associated with an intersection between the first entity and each complementary entity of the plurality of entities;
based on the match request and the computed vector distances, transmit to a second user device associated with a second entity of the one or more second entities an indication comprising a preliminary match with the first entity.

12. The system of claim 11, the non-transitory memory comprises further instructions, that when executed by the one or more processors, are configured to cause the system to transmit to the first user device, an indication of the one or more second entities.

13. The system of claim 11, wherein:
the match request comprises a selection of an intersection bias of a plurality of intersection biases;
each entity intersection comprises a plurality of dimensions each corresponding to a weight; and
the weight is determined based on the selection of the intersection bias.

14. The system of claim 11, wherein each entity intersection comprises a plurality of dimensions each corresponding to a weight and the non-transitory memory comprises further instructions, that when executed by the one or more processors, are configured to cause the system to:
select an intersection bias of a plurality of intersection biases for the match request based on entity data associated with the first entity; and
assign a weight to each dimension of the plurality of dimensions based on the selected intersection bias.

15. The system of claim 11, wherein:
each entity intersection comprises a plurality of dimensions each corresponding to a weight; and
computing a component of the vector distance associated with the descriptive data comprises computing a co-occurrence of dimensions of the descriptive data between the first entity and each complementary entity of the plurality of entities.

16. The system of claim 11, wherein:
each vector of the one or more vectors comprises a plurality of dimensions corresponding to components of the entity data; and
computing a component of the vector distance associated with the quantitative data comprises computing an ordinal rank for each dimension of the plurality of dimensions associated with the quantitative data.

17. The system of claim 11, wherein:
each vector of the one or more vectors comprises a plurality of dimensions corresponding to components of the entity data; and
computing a component of the vector distance associated with the quantitative data comprises normalizing the plurality of dimensions associated with the quantitative data.

18. The system of claim 17, wherein normalizing the plurality of dimensions associated with the quantitative data comprises a method selected from min-max scaling and decimal scaling.

19. The system of claim 11, wherein computing the vector distance comprises a method selected from computing a Euclidean distance, a Minkowski distance, a Manhattan distance, and a Chebyshev distance.

20. The system of claim 11, wherein identifying the one or more second entities further comprises selecting the one or more second entities associated with minimized vector distances.
